(19) United States
(12) Patent Application Publication
(10) Pub. No.: US 2024/0249629 A1
(43) Pub. Date: Jul. 25, 2024

(54) SYSTEM FOR GENERATING AN ANOMALY SIGNAL ON-BOARD AN AIRCRAFT DURING TAKEOFF

(71) Applicant: Airbus Operations SAS, TOULOUSE (FR)

(72) Inventors: Clément SAFON, TOULOUSE (FR); Nicolas MARTIN, TOULOUSE (FR); Chaymae KEROUAD, TOULOUSE (FR)

(21) Appl. No.: 18/419,919

(22) Filed: Jan. 23, 2024

(30) Foreign Application Priority Data
Jan. 25, 2023 (FR) 2300696

(51) Int. Cl. G08G 5/00

(52) U.S. Cl. CPC G08G 5/0065; G08G 5/0021

(57) ABSTRACT

A method for monitoring an aircraft during takeoff is initiated when a first speed threshold is reached. During successive calculation cycles, the following steps are implemented: obtaining a current ground speed; calculating a time taken by a numerical aircraft model to increase its speed to the current ground speed; multiplying this time by the current ground speed and, by integration, deducing therefrom the distance theoretically travelled by the aircraft. Furthermore, the following steps are implemented when a second speed threshold is reached: estimating an acceleration degradation based on a difference between the distance actually travelled by the aircraft and the distance theoretically travelled by the aircraft; and generating a warning when the estimate of the acceleration degradation is greater than a degradation threshold.

### CROSS-REFERENCES TO RELATED APPLICATIONS

This application claims the benefit of French Patent Application Number 2300696 filed on Jan. 25, 2023, the entire disclosure of which is incorporated herein by way of reference.

### FIELD OF THE INVENTION

The present invention relates to the generation of an information, warning or alarm signal on-board an aircraft during takeoff in the event of an anomaly detected when taking off.

### BACKGROUND OF THE INVENTION

The takeoff procedure of an aircraft, from releasing the brakes until the aircraft is in flight, constitutes a difficult phase in the operation of an aircraft. Incidents may take place because of performance losses, changes in respect of the direction and strength of the wind, or for other reasons.

In order to improve safety when taking off, solutions have been worked out in order to provide a pilot of the aircraft with reliable and accurate information allowing them to decide whether the takeoff procedure should be rejected or corrected, and to do so before the aircraft rolling along the runway reaches a critical speed V1. The critical speed V1 is defined as the speed up to which takeoff may be rejected and beyond which takeoff must be continued.

Patent FR 2 650 101 B1 has already disclosed a system for producing an information, warning or alarm signal on-board an aircraft during takeoff in the event of an anomaly when taking off, before the aircraft reaches a critical rolling speed up to which the takeoff process may be modified or rejected and beyond which the takeoff must be continued. This information, warning or alarm signal is delivered only when the speed of the aircraft and the distance travelled by the aircraft along the runway are respectively less than the critical speed V1 and the theoretical distance travelled which is associated therewith, in order to make it possible to reject the takeoff in full safety if necessary. With such a system, however, the transition between the moment at which it is still possible to reject the takeoff and the moment at which it is no longer possible to reject the takeoff is abrupt, and the pilot does not exactly know the moment at which this transition will occur. In the event of a problem, furthermore, the pilot does not at any moment know the braking margin which is available to them.

Furthermore, Patent EP 0 704 783 B1 has already disclosed an improvement to the system proposed by Patent FR 2 650 101 B1, in which new information is provided to the pilot in order to allow the pilot to refine their decision whether or not to continue the takeoff procedure in the event of an anomaly. The improvement proposes, by calculating the distance required by the aircraft (including the distance already travelled) to stop during the acceleration phase of the aircraft during takeoff and comparing it with the runway length available, for the pilot to be provided with continuous information relating to the braking margin, and consequently relating to the decision time which they have left. For example, in the event of a problem during a takeoff with a thrust less than the maximum thrust, if there is still a large decision margin, the pilot may in particular try increasing the thrust and then reject the takeoff a little later if the increase in thrust is not sufficient to achieve a safe situation. One drawback of the improvement proposed by Patent EP 0 704 783 B1 is that it requires large calculation resources, in particular to calculate continuously during takeoff the stopping distance of the aircraft during its acceleration phase on takeoff.

It is therefore desirable to overcome these drawbacks of the prior art. It is, in particular, desirable to provide a solution which makes it possible to assist an aircraft pilot in taking a decision whether or not to reject the takeoff, while limiting the calculation resources required.

### SUMMARY OF THE INVENTION

A method for monitoring an aircraft during takeoff is thus proposed here, the method being implemented by a system in the form of electronic circuitry, the method being initiated when the aircraft reaches a speed greater than a predefined first threshold speed S1, the method having the following steps during successive calculation cycles:
obtaining a current ground speed GS_{c} of the aircraft;
calculating a time Δtₜ taken by a numerical aircraft model to increase its ground speed to the current ground speed GS_{c} from the current ground speed GS_{c} which the aircraft had in the previous calculation cycle;
multiplying the time Δtₜ by the current ground speed GS_{c} of the aircraft observed in the calculation cycle considered and, by integration over all the calculation cycles since the predefined first speed threshold S1 was crossed, deducing therefrom the distance Dₜ theoretically travelled by the aircraft in order to reach the current ground speed GS_{c}.

The method furthermore has the following steps when the aircraft reaches a speed greater than a predefined second speed threshold S2, which is greater than the predefined first speed threshold S1:
calculating an estimate of the acceleration degradation Degr since the predefined first threshold speed S1 was crossed by a calculation corresponding to a ratio between, on the one hand, the difference between the distance actually travelled by the aircraft in order to reach its current ground speed GS_{c} and the distance theoretically travelled by the aircraft in order to reach this current ground speed GS_{c}, and on the other hand the distance theoretically travelled by the aircraft in order to reach this current ground speed GS_{c}; and
generating a warning which informs that a rejected takeoff is recommended when the estimate of the acceleration degradation Degr is greater than a predefined degradation threshold S.

Reliable information to assist a decision to reject the takeoff is thus provided with a low cost in terms of calculation resources.

According to one particular embodiment, the system adjusts the estimate of the acceleration degradation Degr by an approximation reduction constant C.

According to one particular embodiment, the distance Dₜ is calculated in the following way:

$${D}_{t} = \int ( Δ {t}_{t} * G {S}_{c} ) = \int ( ( Δ G {S}_{c} * \frac{G W}{\sum {F}_{n}} ) * G {S}_{c} )$$

where:
ΔGS_{c} represents the variation of the current ground speed GS_{c} since the preceding calculation cycle;
GW represents a gross weight of the aircraft; and
ΣFₙ represents an estimate of the sum of the forces exerted on the aircraft in each calculation cycle considered.

According to one particular embodiment, the sum ΣFₙ of the forces exerted on the aircraft is estimated by a calculation corresponding to:

$$\sum {F}_{n} = T H - D F - ( \frac{S L}{100} * GW \cdot g ) - CR * ( GW * g - LF )$$

where:
TH represents a thrust of the aircraft in the calculation cycle considered;
DF represents a drag force of the aircraft in the calculation cycle considered;
CR represents a ground friction coefficient;
LF represents a lift force of the aircraft in the calculation cycle considered;
g represents the unit of acceleration, i.e. approximately 9.81 m/s²; and
SL represents a runway slope during takeoff, expressed as a percentage.

According to one particular embodiment:
a first calibrated airspeed information item, voted between two redundant computers tasked with the management of the control surfaces, is used to check whether the first predefined speed threshold S1 has been crossed and is also used to check whether the second speed threshold S2 has been crossed, and
a second calibrated airspeed information item, coming from a system of the ADIRS (Air Data Inertial Reference System) type, is used for the calculations of the distance Dₜ.

According to one particular embodiment, the first predefined speed threshold S1 is equal to 35 knots and the second predefined speed threshold S2 is between 75 and 85 knots, preferably equal to 80 knots.

According to one particular embodiment, the system is activated when the speed of the aircraft is greater than a predefined initial speed threshold S0, which is less than the first speed threshold S1.

According to one particular embodiment, the predefined initial speed threshold S0 is equal to 30 knots.

According to one particular embodiment, the predefined degradation threshold S is equal to 15%.

A computer program is also proposed here, which may be stored on a medium and/or downloaded from a communication network in order to be read by a processor. This computer program comprises instructions for implementing the method mentioned above in any one of its embodiments when the said program is executed by the processor. A non-transitory medium for storing information, which stores such a computer program, is also proposed here.

A system is also proposed here for monitoring an aircraft during takeoff in the form of electronic circuitry configured to implement the following steps, when the aircraft reaches a speed greater than a predefined first threshold speed S1, during successive calculation cycles:
obtaining a current ground speed GS_{c} of the aircraft;
calculating a time Δtₜ taken by a numerical aircraft model to increase its ground speed to the current ground speed GS_{c} from the current ground speed GS_{c} which the aircraft had in the previous calculation cycle;
multiplying the time Δtₜ by the current ground speed GS_{c} of the aircraft observed in the calculation cycle considered and, by integration over all the calculation cycles since the predefined first speed threshold S1 was crossed, deducing therefrom the distance Dₜ theoretically travelled by the aircraft in order to reach the current ground speed GS_{c}.

The electronic circuitry is furthermore configured to implement the following steps when the aircraft reaches a speed greater than a predefined second speed threshold S2, which is greater than the predefined first speed threshold S1:
calculating an estimate of the acceleration degradation Degr since the predefined first threshold speed S1 was crossed by a calculation corresponding to a ratio between, on the one hand, the difference between the distance actually travelled by the aircraft in order to reach its current ground speed GS_{c} and the distance theoretically travelled by the aircraft in order to reach this current ground speed GS_{c}, and on the other hand the distance theoretically travelled by the aircraft in order to reach this current ground speed GS_{c}; and
generating a warning which informs that a rejected takeoff is recommended when the estimate of the acceleration degradation Degr is greater than a predefined degradation threshold S.

### BRIEF DESCRIPTION OF THE DRAWINGS

The above-mentioned characteristics of the invention, as well as others, will become clearer on reading the following description of at least one exemplary embodiment, the said description being given with reference to the appended figures, in which:

FIG. 1 schematically illustrates a view from above of an aircraft provided with a takeoff monitoring system;

FIG. 2 schematically illustrates a method for generating a warning signal on-board the aircraft in the event of a lack of acceleration during a takeoff;

FIG. 3A schematically illustrates a first example of integration of the takeoff monitoring system with the avionics of the aircraft;

FIG. 3B schematically illustrates a second example of integration of the takeoff monitoring system with the avionics of the aircraft; and

FIG. 4 schematically illustrates an example of a hardware platform for implementing the takeoff monitoring system in the form of electronic circuitry.

### DETAILED DESCRIPTION OF THE PREFERRED EMBODIMENTS

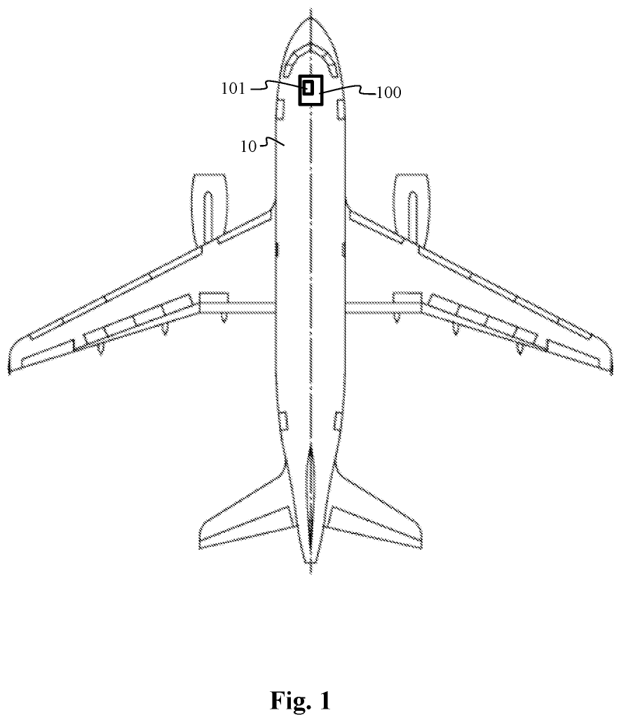

FIG. 1 thus schematically illustrates a view from above of an aircraft 10.

The aircraft 10 has a takeoff monitoring system 101. The takeoff monitoring system 101 is in the form of electronic circuitry, and is typically integrated with the avionics 100.

The avionics 100 also typically have a system of the ADIRS (Air Data Inertial Reference System) type, a system of the FMS (Flight Management System) type, a system of the FADEC (Full Authority Digital Engine Control) type, a system of the FWS (Flight Warning System) type, a system of the EIS (Electronic Information System) type, including in particular a system of the ECAM (Electronic Centralized Aircraft Monitoring) type, a system of the CFDIU (Centralized Fault Display Interface Unit) type, and a system of the SFCC (Slat Flap Control Computer) type. The avionics 100 typically also have other electronic systems.

The takeoff monitoring system 101 is, for example, integrated with a system of the FMGC (Flight Management Guidance Control) type.

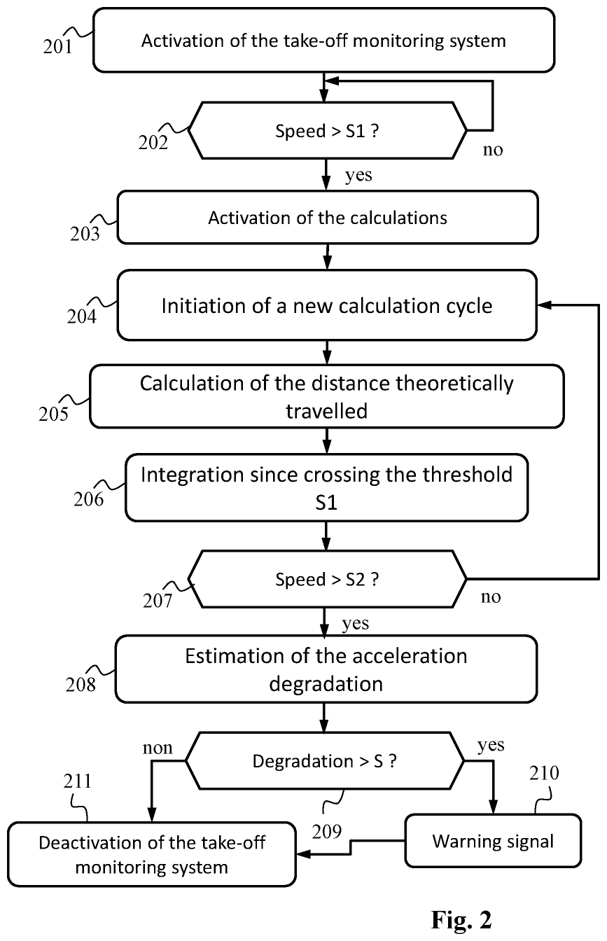

The takeoff monitoring system 101 implements a method for generating a warning signal on-board the aircraft in the event of a lack of acceleration during a takeoff. This method is schematically illustrated in FIG. 2.

In a step 201, the takeoff monitoring system 101 is activated. For example, the takeoff monitoring system 101 is activated when an inhibition signal of the takeoff monitoring system 101 has the value FALSE. The takeoff monitoring system 101 is also activated, for example, when the speed of the aircraft 10 is greater than a predefined initial speed threshold S0. By way of example, the initial speed threshold S0 is set at 30 knots (i.e., approximately 55 km/h) in calibrated airspeed CAS. Indeed, the system of the ADIRS type does not transmit a calibrated airspeed CAS information item below this value, which avoids superfluous processing operations.

In a step 202, the takeoff monitoring system 101 checks whether the aircraft 10 has a calibrated airspeed CAS greater than a first speed threshold S1. The first speed threshold S1 is non-zero and is preferably greater than the initial speed threshold S0. The first speed threshold S1 may, however, be equal to the initial speed threshold S0. The first speed threshold S1 is selected so as to avoid calculations which are expensive in terms of resources in a speed range of the aircraft in which the numerical aircraft model would exhibit high dispersions (in particular due to the variability of the thrust of the aircraft in the first meters of the takeoff). In particular, the first speed threshold S1 makes it possible to obviate calculating any constraint of keeping the aircraft 10 on the runway before initiating the takeoff procedure. For example, the first speed threshold S1 is equal to 35 knots (i.e. approximately 65 km/h). This avoids the need to perform calculations which are expensive in terms of resources in an initial takeoff phase. If the first speed threshold S1 has been reached, a step 203 is consequently carried out; if not, step 202 is repeated.

In step 203, the takeoff monitoring system 101 activates calculations, more particularly of the distance Dₜ theoretically travelled by the aircraft 10, in order to make it possible to obtain an estimate of the acceleration degradation Degr, as will be explained in detail below. The calculations are carried out by calculation cycles.

In a step 204, the takeoff monitoring system 101 initiates a new calculation cycle.

In a step 205, the takeoff monitoring system 101 performs a calculation of the distance theoretically travelled by the aircraft 10 since the initiation of the preceding calculation cycle, and in a step 206 the takeoff monitoring system 101 performs by integration a calculation of the distance Dₜ theoretically travelled by the aircraft 10 since the first speed threshold S1 was crossed.

The distance Dₜ is obtained by a calculation corresponding to:

$${D}_{t} = \int ( Δ {t}_{t} * G {S}_{c} ) = \int ( ( Δ G {S}_{c} * \frac{G W}{\sum {F}_{n}} ) * G {S}_{c} )$$

where:
GS_{c} represents the current ground speed of the aircraft 10 in each calculation cycle considered;
Δtₜ represents the time theoretically taken by the aircraft 10 to increase its ground speed to the current ground speed GS_{c} since the preceding calculation cycle;
ΔGS_{c} represents the variation of the current ground speed GS_{c} since the preceding calculation cycle;
GW represents a gross weight of the aircraft 10; and
ΣFₙ represents an estimate of the sum of the forces exerted on the aircraft 10 in each calculation cycle considered.

In each calculation cycle, the takeoff monitoring system 101 thus calculates the time Δtₜ taken by a numerical aircraft model to increase its ground speed to the current ground speed GS_{c} of the aircraft 10 from the current ground speed which the aircraft 10 had in the previous calculation cycle. The takeoff monitoring system 101 multiplies this time Δtₜ by the current ground speed GS_{c} of the aircraft 10 observed in the calculation cycle considered. Consequently, no theoretical ground speed calculation is carried out, which significantly limits the requirements for calculation resources. Furthermore, by integration over all the calculation cycles since the first speed threshold S1 was crossed, the takeoff monitoring system 101 deduces therefrom the distance Dₜ theoretically travelled by the aircraft 10 in order to reach the current ground speed GS_{c} since the first speed threshold S1 was crossed.

In the very first calculation cycle, the takeoff monitoring system 101 simply stores the information items GS_{c}, GW and ΣFₙ, and/or any information item making it possible to determine them, in order to be able to calculate the distance Dₜ in the next calculation cycle. As a variant, these information items GS_{c}, GW and ΣFₙ, and/or any information item making it possible to determine them, are obtained by the takeoff monitoring system 101 when the initial speed threshold S0 has been crossed. The calculations may thus begin from the very first calculation cycle.

In one particular embodiment, the sum ΣFₙ of the forces (expressed here in newtons or kilonewtons) exerted on the aircraft 10 is estimated in each calculation cycle by a calculation corresponding to:

$$\sum {F}_{n} = T H - D F - ( \frac{S L}{100} * GW \cdot g ) - CR * ( GW * g - LF )$$

where:
TH represents the thrust of the aircraft 10 in the calculation cycle considered;
DF represents the drag force of the aircraft 10 in the calculation cycle considered;
CR represents a ground friction coefficient, for example equal to 0.006;
LF represents the lift force of the aircraft 10 in the calculation cycle considered;
g represents the unit of acceleration, i.e. approximately 9.81 m/s²; and
SL represents the (signed) runway slope during takeoff, expressed here as a percentage.

When the slope of the runway during takeoff is not known accurately by the takeoff monitoring system 101 (for example because this information is not provided by the avionics 100), the slope SL may be set at a default value, for example 1%, or even to a value of zero.

In a step 207, the takeoff monitoring system 101 checks whether the aircraft 10 has a calibrated airspeed CAS greater than a second speed threshold S2. The second speed threshold S2 is strictly greater than the first speed threshold S1. The second speed threshold S2 is preferably set so as to avoid a rejected takeoff RTO at high power. For example, the second speed threshold S2 is between 75 (i.e., approximately 139 km/h) and 85 knots (i.e., approximately 157 km/h), preferably equal to 80 knots (i.e., approximately 148 km/h) or 90 knots (i.e., approximately 167 km/h).

If the second speed threshold S2 has been reached, a step 208 is consequently carried out; if not, step 204 is repeated with the initiation of a new calculation cycle.

In step 208, the takeoff monitoring system 101 calculates the estimate of the acceleration degradation Degr since the first speed threshold S1 was crossed. The takeoff monitoring system 101 calculates this estimate of the acceleration degradation Degr of the aircraft 10 by the calculation corresponding to a ratio between, on the one hand, the difference between the distance actually travelled by the aircraft 10 in order to reach its current ground speed and the distance theoretically travelled by the aircraft 10 in order to reach this current ground speed, and on the other hand the distance theoretically travelled by the aircraft 10 in order to reach this current ground speed.

In one particular embodiment, the acceleration degradation of the aircraft 10 is estimated in the following way:

$$Degr = 100 * \frac{{D}_{r} - {D}_{t}}{{D}_{t}} - C$$

where:
Dᵣ represents the actual distance travelled by the aircraft 10 since the first speed threshold S1 was crossed; and
C is an approximation reduction constant, which may be adjusted empirically as a function of the model of the aircraft 10 considered and which in one embodiment may be zero.

For example, the actual distance Dᵣ is calculated in the following way in each calculation cycle (preferably during step 205, in addition to the calculation of the distance Dₜ):

$${D}_{r} = \int ( Δ {t}_{r} * G {S}_{c} )$$

where Δtᵣ represents the duration of a calculation cycle.

In a step 209, the takeoff monitoring system 101 checks whether the estimate of the acceleration degradation Degr is greater than a predefined degradation threshold S. For example, the degradation threshold S is equal to 15%. Beyond this degradation threshold S, it is assumed that the estimate of the acceleration degradation Degr may be too great to allow takeoff and that a rejected takeoff is recommended. A step 210 is then carried out; if not, a step 211 is carried out.

In step 210, the takeoff monitoring system 101 generates a warning which informs that a rejected takeoff is recommended, for example via the system of the FWS type, the system of the ECAM type and the system of the CFDIU type. This warning may also be recorded in a system of the DFDR (Digital Flight Data Recorder) type by means of a system of the FDIMU (Flight Data Interface & Management Unit) type. Step 211 is then carried out.

In step 211, the takeoff monitoring system 101 is deactivated and the algorithm of FIG. 2 is ended.

In one particular embodiment, the calibrated airspeed CAS information item used comes from various sources: a synchronized calibrated airspeed CAS information item voted between two redundant computers of the FAC (Flight Augmentation Computer) type tasked with the management of the control surfaces, and a standard calibrated airspeed CAS information item coming from a system of the ADIRS type. The synchronized calibrated airspeed CAS information item is then used to check the crossing of the first speed threshold S1 and the crossing of the second speed threshold S2, and the standard calibrated airspeed CAS information item is used to check the crossing of the initial speed threshold S0 and for the calculations of the distance Dₜ.

So as to supply the numerical aircraft model in order to determine the theoretical distance Dₜ as a function of the actual conditions of the aircraft 10, the takeoff monitoring system 101 obtains from the avionics 100 information items relating to measurements performed by sensors which are present at various locations on the aircraft 10 and/or information items which are derived therefrom. In particular, the takeoff monitoring system 101 obtains the following information items from the avionics 100 in real time:
information items relating to the thrust of the aircraft 10 (for example, an information item of the type N1 (speed of rotation of a low-pressure assembly of each propulsion engine) or about the engine pressure ratio (EPR) making it possible, with an information item about the Mach number and a conversion table, to deduce the thrust of the aircraft 10 therefrom;
information items relating to the speed, the ambient conditions, the altitude and the inertial references of the aircraft 10;
information items relating to a current configuration (orientation) of high-lift devices of the leading edge (slats) and high-lift devices of the trailing edge (flaps) of the aircraft 10;
information items about the gross weight GW of the aircraft 10.

These various information items allow the takeoff monitoring system 101 to determine the sum ΣFₙ of the forces exerted on the aircraft 10 by using the numerical aircraft model.

Furthermore, in one particular embodiment, the takeoff monitoring system 101 obtains an information item about the runway slope during takeoff from the avionics 100.

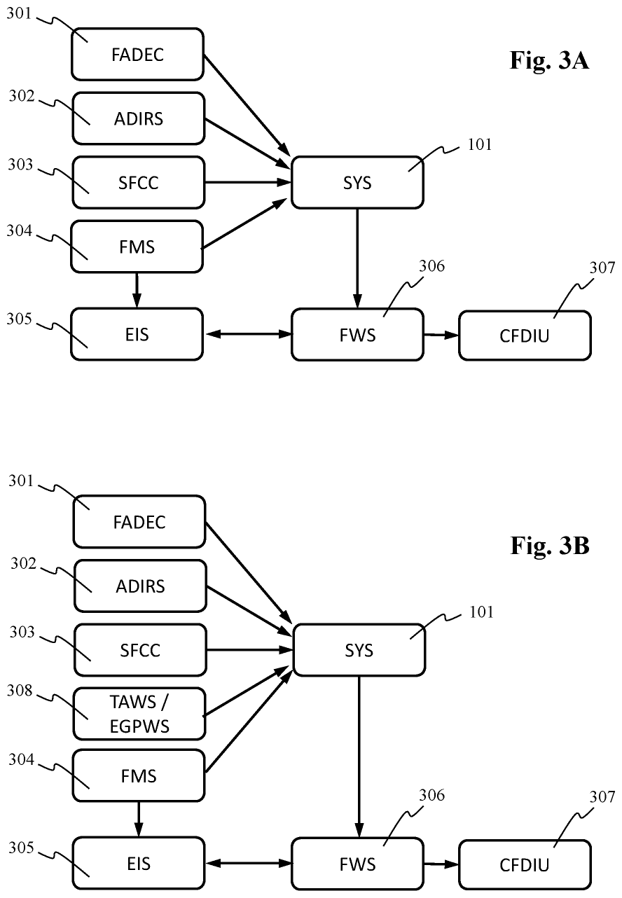

Examples of the integration of the takeoff monitoring system 101 with the avionics 100, which may in particular allow the takeoff monitoring system 101 to obtain these information items, are schematically illustrated in FIGS. 3A and 3B.

As illustrated in FIGS. 3A and 3B, the monitoring system 101 is configured to receive information items coming from the system 301 of the FADEC type, information items coming from the system 302 of the ADIRS type, information items coming from the system 303 of the SFCC type, and information items coming from the system 304 of the FMS type.

Thus, for example, the monitoring system 101 is configured to:
receive, from the system 301 of the FADEC type, the information items relating to the thrust of the aircraft 10, for example information items of the type N1 (speed of rotation of a low-pressure assembly of each propulsion engine), information items about the throttle resolver angle TRA, and optionally information items indicating whether a certain propulsion engine is inoperative;
receive, from the system 302 of the ADIRS type: information items about the current speed of the aircraft 10, for example information items about the calibrated airspeed CAS, the ground speed GS and the Mach number; information items about the ambient conditions, for example information items about the total air temperature TAT and static pressure PSTAT; a current altitude information item (often denoted Zp); and inertial reference information items, for example a current load factor information item (often denoted Nz);
receive, from the system 303 of the SFCC type, the information items relating to the current configuration (orientation) of high-lift devices of the leading edge and high-lift devices of the trailing edge of the aircraft 10; and
receive, from the system 304 of the FMS type, information items about the gross weight GW of the aircraft 10.

The takeoff monitoring system 101 is configured to transmit a warning signal to the system 306 of the FWS type, informing that a rejected takeoff is recommended, when the takeoff monitoring system 101 determines that the estimate of the acceleration degradation Degr is greater than the predefined degradation threshold S. The system 306 of the FWS type is configured in turn to transmit the warning signal, or an information item which is derived therefrom, to the system 307 of the CFDIU type. The pilot of the aircraft 10 is thus informed thereof.

In the example of FIGS. 3A and 3B, the system 304 of the FMS type is configured to provide the system 305 of the EIS type with the inhibition signal of the takeoff monitoring system 101. When this signal has the value FALSE, the takeoff monitoring system 101 is activatable, and when this signal has the value TRUE, the takeoff monitoring system 101 is inhibited. The system 305 of the EIS type is configured to make the system 306 of the FWS type follow the inhibition signal of the takeoff monitoring system 101. The system 306 of the FWS type is configured not to retransmit a warning signal emitted by the takeoff monitoring device 101 to the system 307 of the CFDIU type when the inhibition signal of the takeoff monitoring system 101 has the value TRUE.

In contrast to the FIG. 3A, the example of FIG. 3B makes it possible to take the slope of the runway during takeoff into account. Thus, the monitoring system 101 is configured to receive an information item about the runway slope during takeoff, coming from a system 308 of the TAWS (Terrain Avoidance and Warning System) type and/or of the EGPWS (Enhanced Ground Proximity Warning System) type.

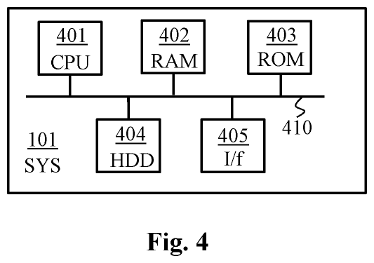

FIG. 4 schematically illustrates an example of a hardware platform for implementing the takeoff monitoring system 101 in the form of electronic circuitry.

The hardware platform then has, connected by a communication bus 410: a processor or CPU (Central Processing Unit) 401; a random-access memory RAM 402; a non-volatile memory 403, for example of the ROM (Read Only Memory) or EEPROM (Electrically-Erasable Programmable ROM) type; a storage unit such as a hard disk drive HDD 404, or a storage medium reader such as an SD (Secure Digital) card reader; and an interface manager I/f 405.

The interface manager I/f 405 allows the takeoff monitoring system 101 to interact with one or more equipment items of the aircraft 10, more particularly equipment items of the avionics 100 of the aircraft 10, as described above in particular with reference to FIGS. 3A and 3B.

The processor 401 is capable of executing instructions loaded into the random-access memory 402 from the non-volatile memory 403, an external memory, a storage medium such as an SD card, or a communication interface. When the hardware platform is powered up, the processor 401 is capable of reading instructions from the random-access memory 402 and executing them. These instructions form a computer programmer causing the processor 401 to implement all or some of the steps and operations described here.

All or some of the steps and operations described here may also be implemented in software form by the execution of an instruction set by a programmable machine, for example a processor of the DSP (Digital Signal Processor) type or a microcontroller, or may be implemented in hardware form by a machine or a dedicated electronic component (chip) or a dedicated set of electronic components (chipset), for example an FPGA (Field Programmable Gate Array) or ASIC (Application Specific Integrated Circuit) component. In general, the takeoff monitoring system 101 includes electronic circuitry adapted and configured to implement the functions and operations described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for monitoring an aircraft during takeoff, the method implemented by a system comprising electronic circuitry, the method being initiated when the aircraft reaches a speed greater than a predefined first threshold speed S1, the method having the following steps during successive calculation cycles:
obtaining a current ground speed GS_{c} of the aircraft;
calculating a time Δtₜ taken by a numerical aircraft model to increase a ground speed to the current ground speed GS_{c} from a current ground speed GS_{c} which the aircraft had in a previous calculation cycle; and,
multiplying the time Δtₜ by the current ground speed GS_{c} of the aircraft observed in the calculation cycle considered and, by integration over all the calculation cycles since the predefined first speed threshold S1 was crossed, deducing therefrom a distance Dₜ theoretically travelled by the aircraft in order to reach the current ground speed GS_{c};
wherein the method further comprises the following steps when the aircraft reaches a speed greater than a predefined second speed threshold S2, which is greater than the predefined first speed threshold S1:
calculating an estimate of an acceleration degradation Degr since the predefined first threshold speed S1 was crossed by a calculation corresponding to a ratio between, on one hand, a difference between a distance actually travelled by the aircraft in order to reach the current ground speed GS_{c} and the distance theoretically travelled by the aircraft in order to reach this current ground speed GS_{c}, and, on another hand, the distance theoretically travelled by the aircraft in order to reach this current ground speed GS_{c}; and
generating a warning which informs that a rejected takeoff is recommended when the estimate of the acceleration degradation Degr is greater than a predefined degradation threshold S.

2. The method according to claim 1, further comprising adjusting the estimate of the acceleration degradation Degr by an approximation reduction constant C.

3. The method according to claim 1, wherein the distance Dₜ is calculated by:
$${D}_{t} = \int ( Δ {t}_{t} * G {S}_{c} ) = \int ( ( Δ G {S}_{c} * \frac{G W}{\sum {F}_{n}} ) * G {S}_{c} )$$
where:
ΔGS_{c} represents a variation of the current ground speed GS_{c} since the preceding calculation cycle;
GW represents a gross weight of the aircraft; and
ΣFₙ represents an estimate of a sum of the forces exerted on the aircraft in each calculation cycle considered.

4. The method according to claim 3, wherein the sum ΣFₙ of the forces exerted on the aircraft is estimated by:
$$\sum {F}_{n} = T H - D F - ( \frac{S L}{100} * GW \cdot g ) - CR * ( GW * g - LF )$$
where:
TH represents a thrust of the aircraft in the calculation cycle considered;
DF represents a drag force of the aircraft in the calculation cycle considered;
CR represents a ground friction coefficient;
LF represents a lift force of the aircraft in the calculation cycle considered;
g represents a unit of acceleration; and
SL represents a runway slope during takeoff, expressed as a percentage.

5. The method according to claim 1, wherein:
a first calibrated airspeed information item, voted between two redundant computers tasked with managing control surfaces, is used to check whether the first predefined speed threshold S1 has been crossed and is also used to check whether the second speed threshold S2 has been crossed, and
a second calibrated airspeed information item, coming from an ADIRS system, is used for the calculations of the distance Dₜ.

6. The method according to claim 1, wherein the first predefined speed threshold S1 is equal to 35 knots and the second predefined speed threshold S2 is between 75 and 85 knots.

7. The method according to claim 1, wherein the system is activated when the speed of the aircraft is greater than a predefined initial speed threshold S0, which is less than the first speed threshold S1.

8. The method according to claim 7, wherein the predefined initial speed threshold S0 is equal to 30 knots.

9. The method according to claim 1, wherein the predefined degradation threshold S is equal to 15%.

10. A system for monitoring an aircraft during takeoff, the system comprising:
electronic circuitry configured to implement the following steps, when the aircraft reaches a speed greater than a predefined first threshold speed S1, during successive calculation cycles:
obtaining a current ground speed GS_{c} of the aircraft;
calculating a time Δtₜ taken by a numerical aircraft model to increase a ground speed to the current ground speed GS_{c} from a current ground speed GS_{c} which the aircraft had in a previous calculation cycle;
multiplying the time Δtₜ by the current ground speed GS_{c} of the aircraft observed in the calculation cycle considered and, by integration over all the calculation cycles since the predefined first speed threshold S1 was crossed, deducing therefrom a distance Dₜ theoretically travelled by the aircraft in order to reach the current ground speed GS_{c};
wherein the electronic circuitry is further configured to implement the following steps when the aircraft reaches a speed greater than a predefined second speed threshold S2, which is greater than the predefined first speed threshold S1:
calculating an estimate of an acceleration degradation Degr since the predefined first threshold speed S1 was crossed by a calculation corresponding to a ratio between, on one hand, a difference between a distance actually travelled by the aircraft in order to reach the current ground speed GS_{c} and the distance theoretically travelled by the aircraft in order to reach this current ground speed GS_{c}, and, on another hand, the distance theoretically travelled by the aircraft in order to reach this current ground speed GS_{c};
and
generating a warning that a rejected takeoff is recommended when the estimate of the acceleration degradation Degr is greater than a predefined degradation threshold S.
